(19) United States
(12) Patent Application Publication
(10) Pub. No.: US 2011/0252356 A1
(43) Pub. Date: Oct. 13, 2011

(54) METHODS, SYSTEMS, AND COMPUTER PROGRAM PRODUCTS FOR IDENTIFYING AN IDLE USER INTERFACE ELEMENT

(76) Inventor: Robert Paul Morris, Raleigh, NC (US)

(21) Appl. No.: 12/758,828

(22) Filed: Apr. 13, 2010

(51) Int. Cl. G06F 3/048

(52) U.S. Cl. 715/772

(57) ABSTRACT

Methods and systems are described for identifying an idle user interface element. In one aspect, a user interface element is identified that includes a user detectable representation of data processed by an application. An idle period is identified by determining the user interface element is not updated, by the application in response to a change in the data, during the idle period. A determination is made that a specified condition is met for the idle period. In response to the determination, idle information is sent to present a user detectable idle indication for the user interface element.

### RELATED APPLICATIONS

This application is related to the following commonly owned U.S. Patent Application, the entire disclosure being incorporated by reference herein: Application No. 12/758,125 (Docket No 0127) filed on Apr. 12, 2010 entitled “Methods, Systems, and Program Products Managing an Idle Computing Component.”

### BACKGROUND

Current energy management systems in some computing devices can detect when a device is idle by detecting no user input over a given time period. In response, some systems change the power state of an entire device by entering a low power state referred to as “suspending” the device or putting the device to “sleep.” Some operating systems allow a user to place a device in hibernate mode. In hibernation, the current state of the system is copied from the device's processor memory to a persistent data store, such as a hard drive. The device is subsequently powered down. A device in hibernate mode may be restarted to restore the saved system state instead of performing a fresh boot.

In some cases, however, a device that a user is not interacting with is not idle. Lack of Input from a user is not always an accurate indication and/or sufficient indication that a device is idle or even that a particular application is idle. Further, current solutions do not address energy management while a user is actively using a device. A look at process activity on many devices reveals that many, if not most, processes are using little, if any, processor time although they typically are using other system resources that require energy and have other costs. Some of these processes and/or included threads are operating system and/or service processes that provide services to one or more applications. A network stack and antivirus monitor are examples. Such service processes rarely have active user interfaces presented on a display, audio, and/or other output device for presentation to a user.

Processes with active user interfaces visible or otherwise detectable to a user are typically processes under control of a user. Users are usually left with the decision of whether to leave such processes and their included components operating or not. Processes, with presented user interfaces, that are neglected by users may be utilizing energy and other system resources unnecessarily.

Some web applications, providing a user interface in a browser of a client device, present a message or other indication that a session between the client device and the web application has timed out. This does not occur until a request is sent to the web application. Such requests require user input. By the time a session timeout indication is presented, the session may have been inactive for quite some time. Thus session timeout indications are often not timely, require a user input, and client device resources are utilized to support the user interface of the web application at least until a session timeout indication is presented.

Some current systems can detect non-responsive interface elements. Non-responsive interface elements are presented by processes that are blocked and/or too busy to process detected user input targeted to the application via the user interface of the application. Non-responsive user interface elements and applications are identified in current systems in response to detecting user input corresponding to the user interface elements for processing by their respective applications.

Accordingly, there exists a need for methods, systems, and computer program products for identifying an idle user interface element.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for identifying an idle user interface element. In one aspect, the method includes identifying a user interface element, including a user detectable representation of data processed by an application, presented by the application via an output device. The method further includes identifying an idle period by determining the user interface element is not updated, by the application in response to a change in the data, during the idle period. The method still further includes determining that a specified idle condition for the idle period is met. The method also includes, sending, in response to determining the idle condition is met, idle information to present a user detectable idle indication for the user interface element.

Further, a system for identifying an idle user interface element is described. The system includes an execution environment including an instruction-processing unit configured to process an instruction included in at least one of an application monitor component, an idle monitor component, an idle policy component, and a policy agent component. The system includes the application monitor component configured for identifying a user interface element, including a user detectable representation of data processed by an application, presented by the application via an output device. The system further includes the idle monitor component configured for identifying an idle period by determining the user interface element is not updated, by the application in response to a change in the data, during the idle period. The system still further includes the idle policy component configured for, determining that a specified idle condition for the idle period is met. The system also includes the policy agent component configured for sending, in response to determining the idle condition is met, idle information to present a user detectable idle indication for the user interface element.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for identifying an idle user interface element according to an aspect of the subject matter described herein;

FIG. 3 is a block diagram illustrating an arrangement of components for identifying an idle user interface element according to another aspect of the subject matter described herein;

FIG. 4a is a block diagram illustrating an arrangement of components for identifying an idle user interface element according to another aspect of the subject matter described herein;

FIG. 4b is a block diagram illustrating an arrangement of components for identifying an idle user interface element according to another aspect of the subject matter described herein;

FIG. 4c is a block diagram illustrating an arrangement of components for identifying an idle user interface element according to another aspect of the subject matter described herein;

FIG. 5 is a block diagram illustrating an arrangement of components for identifying an idle user interface element according to another aspect of the subject matter described herein;

FIG. 6 is a network diagram illustrating an exemplary system for identifying an idle user interface element according to an aspect of the subject matter described herein;

FIG. 7a is a diagram illustrating a user interface presented by a display according to an aspect of the subject matter described herein;

FIG. 7b is a diagram illustrating a user interface presented by a display according to an aspect of the subject matter described herein; and

FIG. 7c is a diagram illustrating a user interface presented by a display according to an aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art that one or more aspects of the disclosure may be practiced with a lesser degree of these specific details. In other instances, well-known structures and devices are shown in block diagram form in order to facilitate describing one or more aspects of the disclosure.

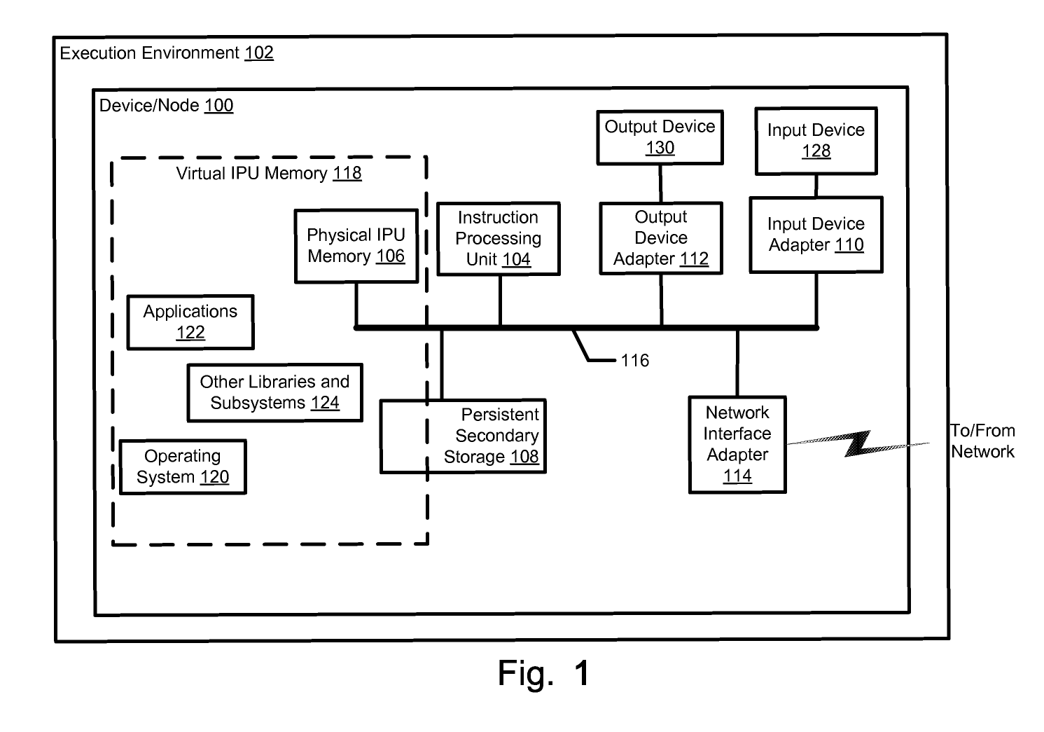

An exemplary device included in an execution environment that may be configured according to the subject matter is illustrated in FIG. 1. An execution environment includes an arrangement of hardware and, optionally, software that may be further configured to include an arrangement of components for performing a method of the subject matter described herein.

An execution environment includes and/or is otherwise provided by one or more devices. An execution environment may include a virtual execution environment including software components operating in a host execution environment. Exemplary devices included in or otherwise providing suitable execution environments for configuring according to the subject matter include personal computers, notebook computers, tablet computers, servers, hand-held and other mobile devices, multiprocessor devices, distributed devices, consumer electronic devices, and/or network-enabled devices. Those skilled in the art will understand that the components illustrated in FIG. 1 are exemplary and may vary by particular execution environment

FIG. 1 illustrates hardware device 100 included in execution environment 102. Hardware device 100 as illustrated includes instruction-processing unit (IPU) 104, such as one or more microprocessors; physical processor memory 106 including storage locations identified by addresses in a physical memory address space of IPU 104; persistent secondary storage 108, such as one or more hard drives and/or flash storage media; input device adapter 110, such as a key or keypad hardware, a keyboard adapter, and/or a mouse adapter; output device adapter 112, such as a display or audio adapter for presenting information to a user; a network interface, illustrated by network interface adapter 114, for communicating via a network such as a LAN and/or WAN; and a communication mechanism that couples elements 104-114, illustrated as bus 116. Elements 104-114 may be operatively coupled by various means. Bus 116 may comprise any type of bus architecture, including a memory bus, a peripheral bus, a local bus, and/or a switching fabric.

IPU 104 is an instruction execution machine, apparatus, or device. Exemplary IPUs include one or more microprocessors, digital signal processors (DSP), graphics processing units (GPU), application-specific integrated circuits (ASIC), and/or field programmable gate arrays (FPGA). In the description of the subject matter herein, the terms “IPU” and “processor” are used interchangeably. IPU 104 may access machine code instructions and data via one or more memory address spaces in addition to the physical memory address space. A memory address space includes addresses identifying locations in a processor memory. The addresses in a memory address space define a processor memory. IPU 104 may have more than one processor memory. Thus, IPU 104 may have more than one memory address space. IPU 104 may access a location in a processor memory by processing an address identifying the location. The processed address may be in an operand of a machine code instruction and/or may be identified in a register or other portion of IPU 104.

FIG. 1 illustrates virtual processor memory 118 spanning at least part of physical processor memory 106 and at least part of persistent secondary storage 108. Virtual memory addresses in a memory address space may be mapped to physical memory addresses identifying locations in physical processor memory 106. An address space for identifying locations in a virtual processor memory is referred to as a virtual memory address space; its addresses are referred to as virtual memory addresses; and its processor memory is known as a virtual processor memory or virtual memory. The term “processor memory” may refer to physical processor memory 106 and/or virtual processor memory 118 depending on the context in which the term is used.

Various types of memory technologies may be included in physical processor memory 106. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), and/or RAMBUS DRAM (RDRAM). Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one more magnetic disk drives, and/or one or more optical disk drives. Persistent secondary storage may include removable media. The drives and their associated computer-readable storage media provide volatile and/or nonvolatile storage for computer readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including operating system 120, one or more applications 122, other program code and/or data components illustrated by other libraries and subsystems 124. In an aspect, some or all software components may be stored in locations accessed by IPU 104 in a shared memory address space shared by the software components. The software components accessed via the shared memory address space are stored in a shared processor memory defined by the shared memory address space. In another aspect, a first software component may be stored in one or more locations accessed by IPU 104 in a first address space and a second software component may be stored in one or more locations accessed by IPU 104 in a second address space. The first software component is stored in a first processor memory defined by the first address space and the second software component is stored in a second processor memory defined by the second address space.

Software components typically include instructions executed by IPU 104 in a context of a process. A process may include one or more threads. A thread includes a sequence of instructions executed by IPU 104 in a thread context. The terms “thread” and “process” may be used interchangeably herein when a process includes only one thread. Program code for a particular application and/or service may be executed in one or more processes. A process including application code is referred to herein as an “application process” or “application.”

Execution environment 102 may receive user-provided information via one or more input devices illustrated by input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such a serial port, a parallel port, and/or a universal serial bus (USB) port. Input device adapter 110 receives input and provides a representation to bus 116 to be received by IPU 104, physical processor memory 106, and/or other components included in execution environment 102.

Output device 130 in FIG. 1 exemplifies one or more output devices that may be included in and/or may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion producing devices, and other output devices producing sensory information detectable by a user.

A device included in or otherwise providing an execution environment may operate in a networked environment communicating with one or more devices via one or more network interfaces. The terms communication interface and network interface are used interchangeably. FIG. 1 illustrates network interface adapter 114 as a network interface included in execution environment 102 to operatively couple device 100 to a network. The terms network node and node in this document both refer to a device having a network interface for operatively coupling the device to a network.

Exemplary network interfaces include wireless network adapters and wired network adapters. Exemplary wireless networks include a BLUETOOTH network, a wireless 802.11 network, and/or a wireless telephony network (e.g., a cellular, PCS, CDMA, and/or GSM network). Exemplary wired networks include various types of LAN, WANS, and personal area networks (PANs). Exemplary network adapters for wired networks include Ethernet adapters, Token-ring adapters, FDDI adapters, asynchronous transfer mode (ATM) adapters, and modems of various types. Exemplary networks also include intranets and internets such as the Internet.

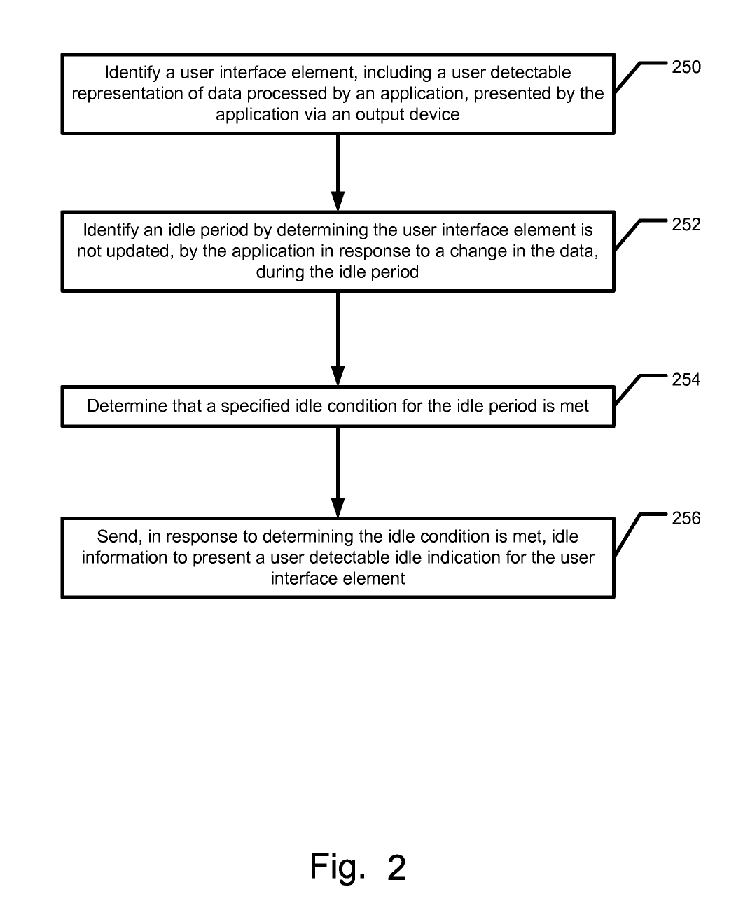

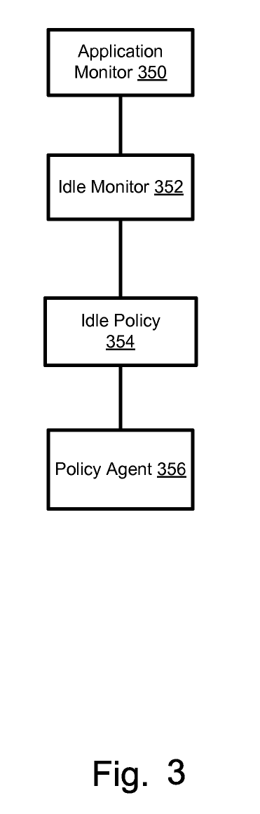

FIG. 2 is a flow diagram illustrating a method for identifying an idle user interface element according to an exemplary aspect of the subject matter described herein. FIG. 3 is a block diagram illustrating a system for identifying an idle user interface element according to another exemplary aspect of the subject matter described herein. A system for identifying an idle user interface element includes an execution environment, such as execution environment 102 in FIG. 1, including an instruction-processing unit, such as processor 104, configured to process an instruction included in at least one of application monitor component 350, idle monitor component 352, idle policy component 354, and policy agent component 356 illustrated in FIG. 3.

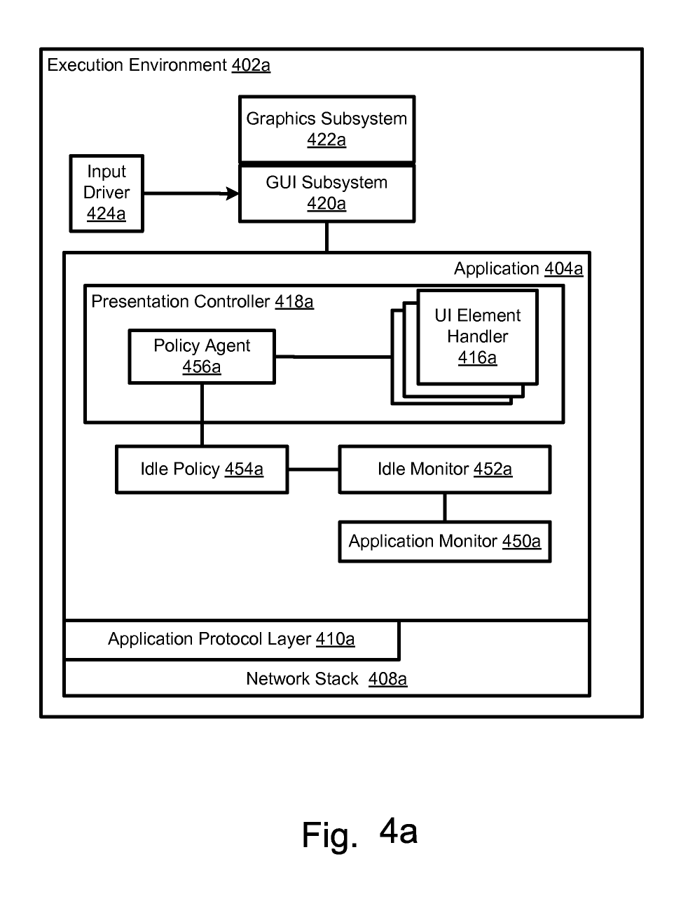

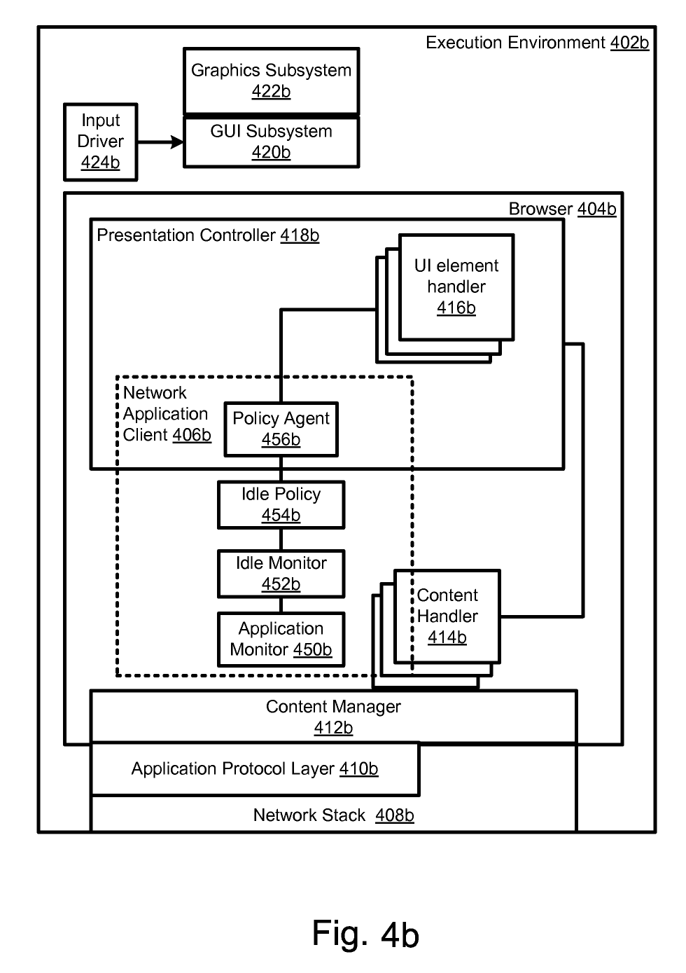

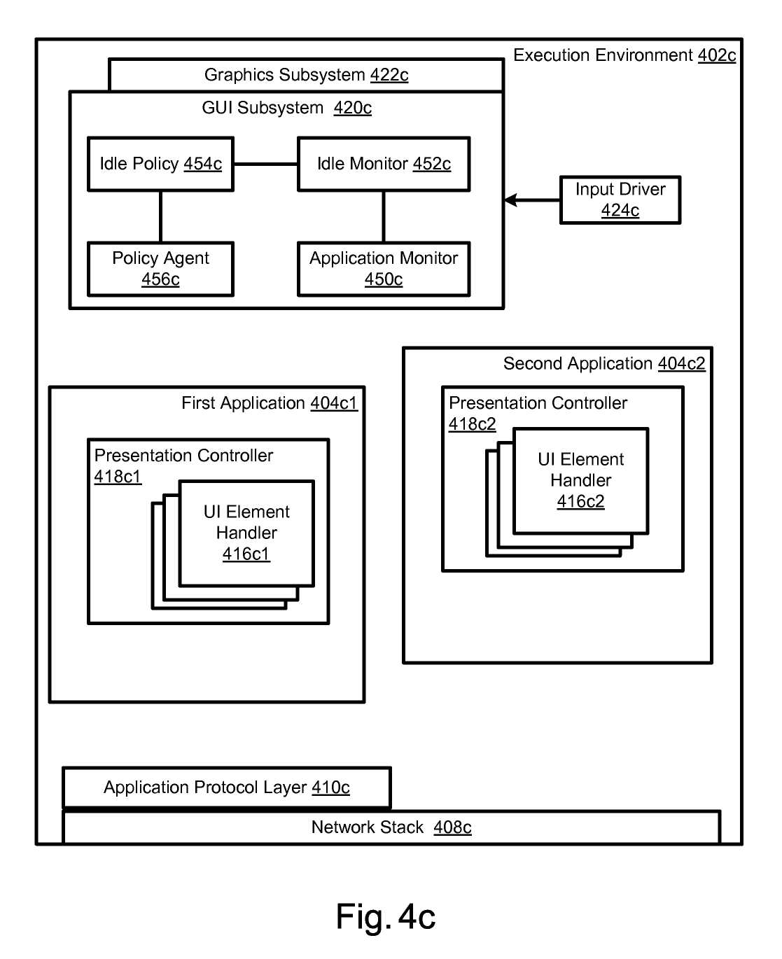

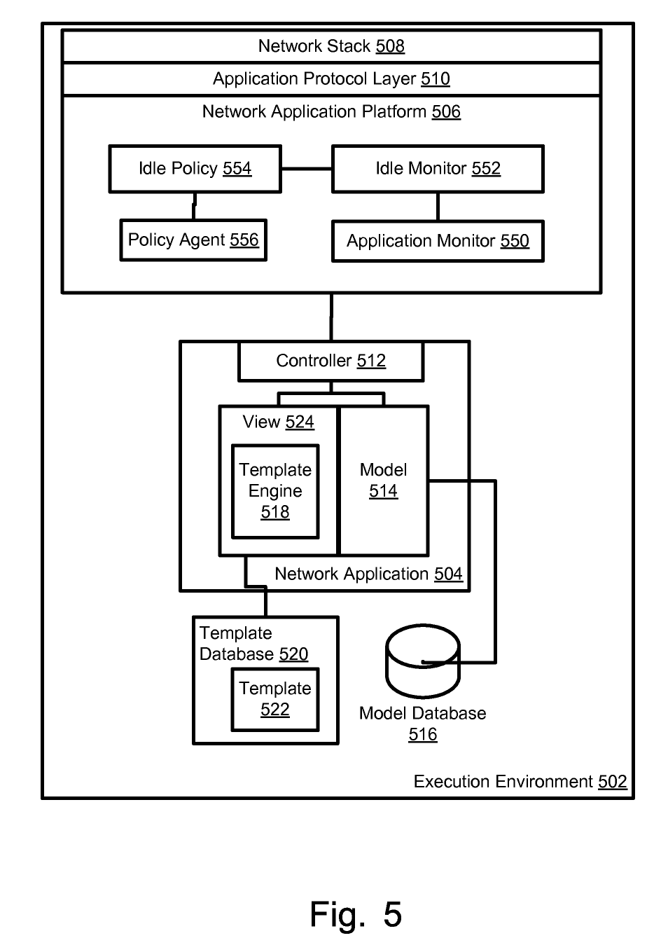

The components illustrated in FIG. 3 may be adapted for performing the method illustrated in FIG. 2 in a number of execution environments. Adaptations of the components illustrated in FIG. 3 for performing the method illustrated in FIG. 2 are described operating in exemplary execution environments 402 illustrated in FIG. 4a, FIG. 4b, and also in FIG. 4c; and exemplary execution environment 502 illustrated in FIG. 5.

FIG. 1 illustrates components of an exemplary device that may at least partially provide and/or otherwise may be included in an exemplary execution environment, such as those illustrated in FIG. 4a, FIG. 4b, FIG. 4c, and FIG. 5. The components illustrated in FIG. 3, FIG. 4a, FIG. 4b, FIG. 4c, and FIG. 5 may be included in or otherwise combined with the components of FIG. 1 to create a variety of arrangements of components according to the subject matter described herein.

Component identifiers including postfixes including letters and/or numbers in the figures are referred to collectively using the respective identifiers without the postfixes and with partial postfixes, and, in some cases are generically referred to across the figures in the same manner when the including description applies to more than one of the illustrated components.

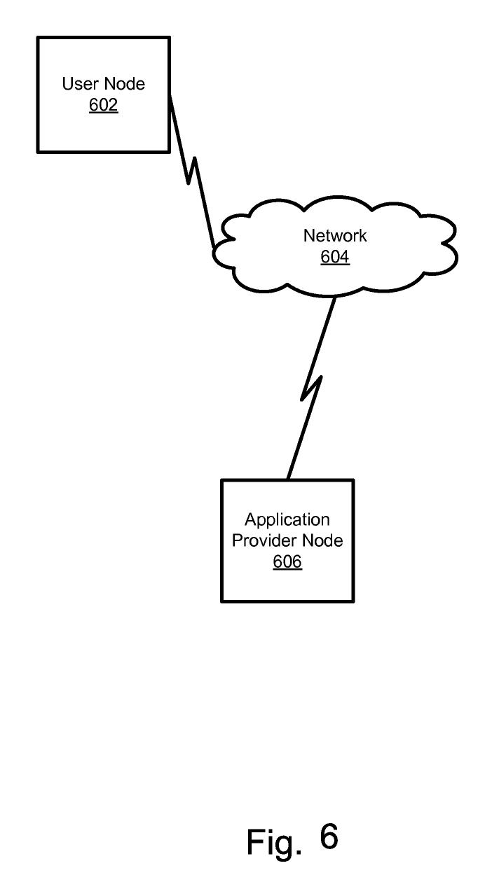

FIG. 6 illustrates user node 602 as an exemplary device that in various aspects may be included in and/or otherwise adapted for providing any of execution environments 402 illustrated in FIG. 4a, FIG. 4b, and FIG. 4c each illustrating a different adaptation of the arrangement of components in FIG. 3. As illustrated in FIG. 6, user node 602 is operatively coupled to network 604 via a network interface, such as NIC 114. Alternatively or additionally, an adaptation of an execution environment 402 may include and/or may otherwise be provided by a device that is not operatively coupled to a network. Application provider node 606 may be included in and/or otherwise adapted for providing execution environment 502 illustrated in FIG. 5. As illustrated in FIG. 6, application provider node 606 is operatively coupled to network 604 via a network interface included in execution environment 502.

FIG. 4a illustrates execution environment 402a hosting application 404a including an adaptation of the arrangement of components in FIG. 3. FIG. 4b illustrates execution environment 402b hosting browser 404b application including an adaptation of the arrangement of components in FIG. 3 that may operate at least partially in a web client application 406b received from a remote application provider, such as network application 504 in FIG. 5. Browser 404b and execution environment 402b may provide at least part of an execution environment for network application client 406b. FIG. 4c illustrates an arrangement of the components in FIG. 3 adapted to operate in a presentation subsystem of execution environment 402c. The arrangement in FIG. 4c may mediate communication between applications 404c and one or more output devices, such as display 130 in FIG. 1.

FIG. 5 illustrates execution environment 502 configured to host one or more remote application providers illustrated by network application 504. FIG. 5 also illustrates network application platform 506 that may provide services to one or more network applications. Network application platform 506 includes yet another adaptation of the arrangement of components in FIG. 3.

The various adaptations of the arrangement in FIG. 3 are not exhaustive. For example, those skilled in the art will see based on the description herein that arrangements of components for performing the method illustrated in FIG. 2 may be at least partially included in an application and at least partially external to the application. Further, arrangements for performing the method illustrated in FIG. 2 may be distributed across more than one node and/or execution environment. For example, such an arrangement may operate at least partially in browser 404b in FIG. 4b and at least partially in execution environment 502 in and/or external to network application 504.

FIG. 4a, FIG. 4b, and FIG. 4c illustrate adaptations of network stacks 408 configured for sending and receiving messages over a network, such as network 604, via a network interface. FIG. 5 illustrates a network application platform 506 providing services to one or more network applications. In various aspects, network application platform 506 may include and/or interoperate with a web server. FIG. 5 also illustrates network application platform 506 configured for interoperating with network stack 508. Network stack 508 serves a role analogous to network stacks 408 operating in respective execution environments 402.

Network stacks 408 and network stack 508 may support the same protocol suite, such as TCP/IP, or may communicate via a network gateway or other protocol translation device and/or service. For example, browser 404b in FIG. 4b and network application platform 506 in FIG. 5 may interoperate via their respective network stacks; network stack 408b and network stack 508.

FIG. 4a, FIG. 4b, and FIG. 4c illustrate applications 404; and FIG. 5 illustrates network application 504, respectively, which may communicate via one or more application layer protocols. FIG. 4a, FIG. 4b, and FIG. 4c illustrate application protocol layers 410 for communicating via one or more application layer protocols. Exemplary application protocols include hypertext transfer protocol (HTTP) and instant messaging and presence (XMPP-IM) protocol. FIG. 5 illustrates a compatible application protocol layer as application protocol layer 510. Matching protocols enabling applications 404 supported by one or more user nodes 602 to communicate with network application 504 of application provider node 606 via network 604 in FIG. 6 are not required, if communication is via a protocol gateway or other translator.

In FIG. 4b, browser 404b may receive some or all of network application client 406b in one more messages sent from a network application, such as network application 504 via network application platform 506, a network stack, a network interface, and optionally an application protocol layer. In FIG. 4b, browser 404b includes content manager 412b. Content manager 412b may interoperate with one or more of application protocol layer 410b and/or network stack 408b to receive the message or messages including some or all of network application client 406b.

Network application client 406b may include a web page for presenting a user interface for network application 504. The web page may include and/or reference data represented in one or more formats including hypertext markup language (HTML) and/or other markup language, ECMAScript or other scripting language, byte code, image data, audio data, and/or machine code.

In an example, in response to a request received from browser 404b, controller 512, in FIG. 5, may invoke model subsystem 514 to perform request specific processing. Model subsystem 514 may include any number of request handlers (not shown) for dynamically generating data and/or retrieving data from model database 516 based on the request. Controller 512 may further invoke template engine 518 to identify one or more templates and/or static data elements for generating a user interface for representing a response to the received request. FIG. 5 illustrates template database 520 including exemplary template 522. FIG. 5 illustrates template engine 518 as a component in view subsystem 524 configured to return responses to processed requests in a presentation format suitable for a client, such as browser 404b. View subsystem 524 may provide the presentation data to controller 512 to send to browser 404b in response to the request received from browser 404b. Some or all of network application client 406b may be sent to browser 404b via network application platform 506 as described above.

While the example describes sending some or all of network application client 406b in response to a request, network application 504 additionally or alternatively, may send some or all of a network application client to browser 404b via one or more asynchronous messages. An asynchronous message may be sent in response to a change detected by network application 504. Publish-subscribe protocols, such as the presence protocol specified by XMPP-IM, are exemplary protocols for sending messages asynchronously.

The one or more messages including information representing some or all of network application client 406b in FIG. 4b may be received by content manager 412b via one or more of application protocol layer 410b and network stack 408b as described above. In FIG. 4b, browser 404b includes one or more content handlers 414b to process received data according to its data type, typically identified by a MIME-type identifier. Exemplary content handlers 414b include a text/html content handler for processing HTML documents; an application/xmpp-xml content handler for processing XMPP streams including presence tuples, instant messages, and publish-subscribe data as defined by various XMPP specifications; one or more video content handler components for processing video streams of various types; and still image data content handler components for processing various images types. Content handler components 414b process received data and may provide a representation of the processed data to one or more user interface (UI) element handlers 416b.

UI element handlers 416 are illustrated in presentation controllers 418 in FIG. 4a, FIG. 4b, and FIG. 4c. A presentation controller 418 may manage the visual, audio, and/or other types of output of its including application 404 as well as receive and route detected user and other inputs to components and extensions of its including application 404. With respect to FIG. 4b, a UI element handler 416b in various aspects may be adapted to operate at least partially in a content handler 414b such as a text/html content handler and/or a script content handler. Additionally or alternatively, a UI element handler 416 in an execution environments 402 may operate in and/or as an extension of its including application 404, such as a plug-in providing a virtual machine for script and/or byte code and/or external to an interoperating application 404.

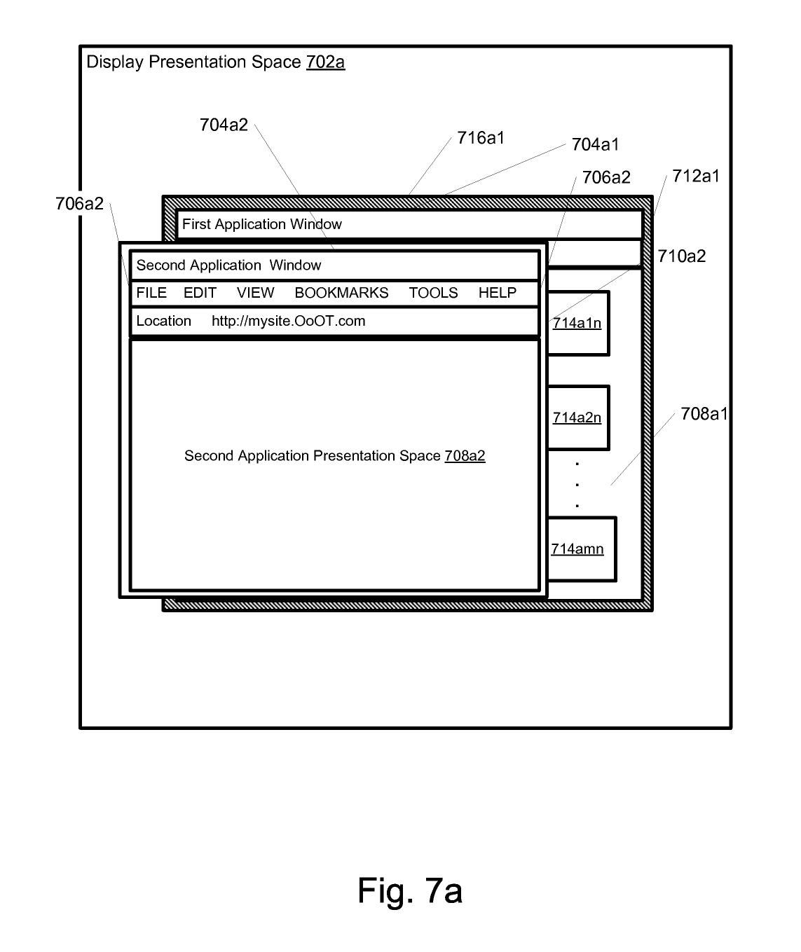

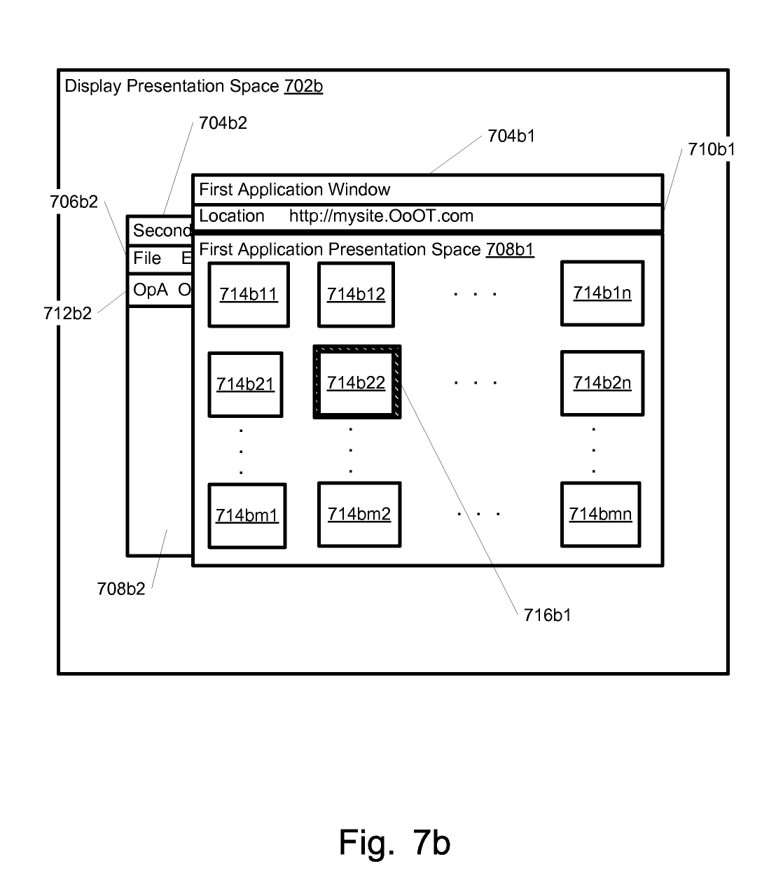

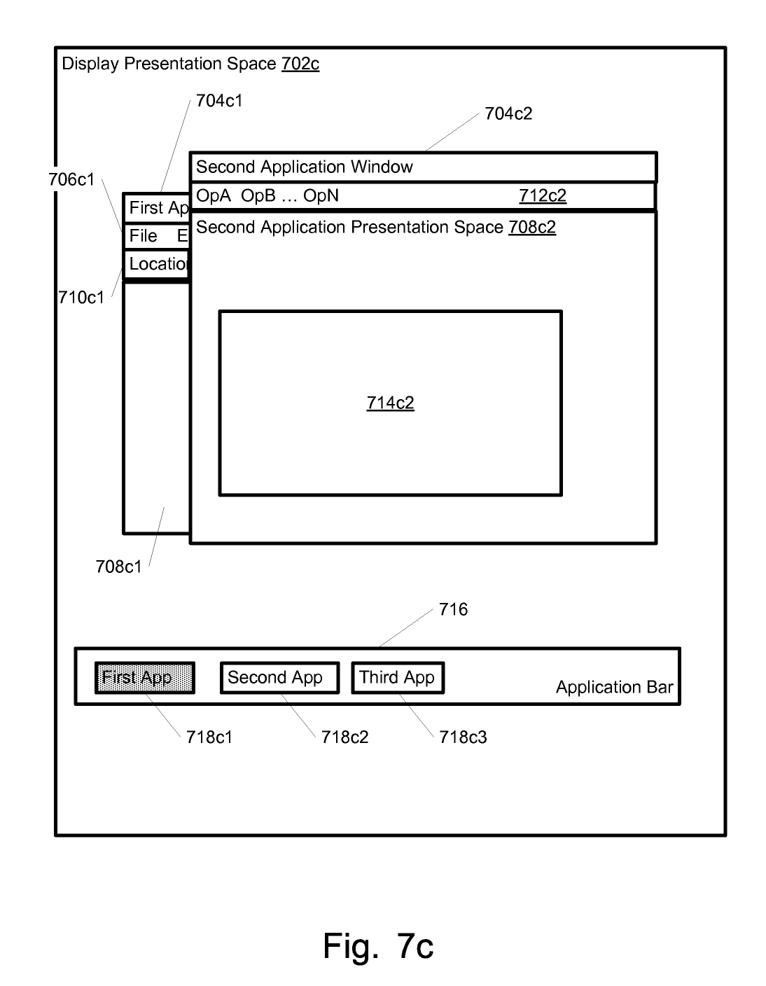

FIG. 7a, FIG. 7b, and FIG. 7c respectively illustrate presentation spaces 702 of respective displays including various application windows 704 of several applications 404, network application client 406b, and/or network application 504. FIG. 7a, FIG. 7b, and FIG. 7c illustrate user interfaces of various applications 404 operating in execution environments 402 in FIG. 4a, FIG. 4b, and FIG. 4c, and network application 504 in execution environment 502 in FIG. 5.

The components of a user interface are generically referred to herein as UI elements. More specifically, visual components of a user interface are referred to herein as visual interface elements. A visual interface element may be a visual component of a graphical user interface (GUI). Exemplary visual interface elements include windows, textboxes, various types of button controls including check boxes and radio buttons, sliders, list boxes, drop-down lists, spinners, various types of menus, toolbars, ribbons, combo boxes, tree views, grid views, navigation tabs, scrollbars, labels, tooltips, text in various fonts, balloons, and dialog boxes. An interface of an application may include one or more of the exemplary elements listed. Those skilled in the art will understand that this list is not exhaustive. The terms visual representation, visual component, and visual interface element are used interchangeably in this document.

Other types of UI elements include audio output components referred to as audio interface elements, tactile output components referred to a tactile interface elements, and the like.

A “UI element handler” component, as the term is used in this document, includes a component configured to send information representing a program entity for presenting a user detectable representation of the program entity by an output device, such as a display. The user detectable representation is presented based on the sent information. The sent information is referred to herein as representation information.

Representation information includes data in one or more formats. Exemplary formats include image formats such as JPEG, video formats such as MP4, markup language data such as HTML and other XML-based markup, and/or instructions such as those defined by various script languages, byte code, and/or machine code. For example, a web page received by a browser may include HTML ECMAScript, image data, and/or byte code for presenting one or more UI elements included in a user interface of an application.

Components configured to send information representing one or more program entities for presenting particular types of output by particular types of output devices include visual interface element handlers, audio interface element handlers, tactile interface element handlers, and the like.

A program entity is an object included in and/or otherwise processed by an application or executable program component. A representation of a program entity may be represented and/or otherwise maintained in a presentation space.

As used in this document, the term presentation space refers to a storage region allocated and/or otherwise provided for storing some or all of an audio, visual, tactile, and/or other sensory data for presentation by and/or on an output device. For example, a buffer for storing an image and/or text string may be a presentation space. A presentation space may be physically and/or logically contiguous or non-contiguous. A presentation space may have a virtual as well as a physical representation. A presentation space may include a storage location in a processor memory, a secondary storage, a memory of an output adapter device, and/or a storage medium of an output device. A screen of a display, for example, is a presentation space.

As used herein, the term “program” refers to any data representation that is and/or may be translated into a set of machine code instructions and associated program data, if any. A program or executable may include an application, a shared or non-shared library, and a system command. Program representations other than machine code include object code, byte code, and source code. Object code includes a set of instructions and/or data elements that either are prepared for linking prior to loading or are loaded into a processor memory. This definition includes machine code and virtual machine code, such as Java™ byte code.

As used herein, an “addressable entity” is a program entity specifiable in a source code language and accessible to an IPU via an address when stored in a processor memory in an executable representation. Examples of addressable entities include variables such as structures, constants including structured constants, functions, subroutines, methods, classes, anonymous scoped instruction sets, and individual instructions, which may be labeled. Strictly speaking, the addressable entity contains a value or an instruction, but it is not the value or the instruction. In some places, this document will use addressable entity in a manner that refers to the content and/or value of an addressable entity. In these cases, the context will clearly indicate the intended meaning.

Addressable entities may have a number of corresponding representations. These representations include source code, object code, and any intermediate formats processed by an interpreter, compiler, linker, loader, source code editor, pre-processors, syntax checkers, or other related tool. Thus, terms such as addressable source code entity may be used in cases where the format is relevant and may be unclear from the context.

Application windows 704 in FIG. 7a, FIG. 7b, and FIG. 7c illustrate a number of visual UI elements commonly presented by applications. One or more application windows 704 include respective menu bars 706 with menu controls for receiving user input to identify commands to perform. Application windows 704 also include respective UI elements providing respective application presentation spaces 708 for presenting representations of data processed by respective applications 404. One or more of the application windows 704 may be windows presented by one or more browser applications. For example, first application window 704b1 in FIG. 7b may be presented by browser 404b in FIG. 4b. A browser window may include a user interface of a network application provided by a remote node, such as a network application 504 in FIG. 5. Browser windows, as well as other application user interfaces, may include location bars 710 identifying content presented in an application presentation space 708. First application window 704a1 in FIG. 7a, second application window 704b2 in FIG. 7b, and second application window 704c2 in FIG. 7c include respective operation bars 712 including user interface controls for selecting one or more operations to perform on one or more data representation elements 714 which may be representations of application processed data.

Various UI elements of applications 404 and network application 504 described above may be presented by one or more UI element handler components 416 in FIG. 4a, FIG. 4b, and FIG. 4c; and/or by one or more templates engines 518 in FIG. 5. In an aspect, illustrated in FIG. 4a, FIG. 4b, and in FIG. 4c, UI element handler(s) 416 of one or more applications 404 is/are configured to send representation information representing a visual interface element, such as menu a bar 706 in FIG. 7a, FIG. 7b, and FIG. 7c, to a GUI subsystem 420. A GUI subsystem 420 may instruct a graphics subsystem 422 to draw the visual interface element in a region of a corresponding display presentation space 702, based on representation information received from a corresponding UI element handler 416.

Input may be received corresponding to a UI element via an input driver 424 illustrated in FIG. 4a, FIG. 4b, and FIG. 4c in various adaptations. For example, a user may move a mouse to move a pointer presented in a display presentation space 702 over a menu item identified in a menu bar 706. The user may provide an input detected by the mouse. The detected input may be received by a GUI subsystem 420 via an input driver 424 as an operation or command indicator based on the association of the shared location of the pointer and the menu item in the display presentation space 702.

With reference to FIG. 2, block 250 illustrates the method includes identifying a user interface element, including a user detectable representation of data processed by an application, presented by the application via an output device. Accordingly, a system for identifying an idle user interface element includes means for identifying a user interface element, including a user detectable representation of data processed by an application, presented by the application via an output device. For example, as illustrated in FIG. 3, application monitor component 350 is configured for identifying a user interface element, including a user detectable representation of data processed by an application, presented by the application via an output device.

FIG. 4a, FIG. 4b, and FIG. 4c illustrate application monitor components 450 as adaptations and/or analogs of application monitor component 350 in FIG. 3. One or more application monitor components 450 operate in an execution environment 402. In FIG. 4a, application monitor component 450a is illustrated as a component of application 404a. In FIG. 4b, application monitor component 450b is illustrated as component of network application client 406b. In FIG. 4c, application monitor component 450c is illustrated operating external to one or more applications 404c. Execution environment 402c includes application monitor component 450c in GUI subsystem 420c. In FIG. 5, application monitor component 550 is illustrated operating in network application platform 506 servicing network application 504 and remote from an output device for presenting a UI element. For example, application monitor component 550 may operate in application provider node 606 while a UI element presented by network application 504 is presented on a display device of user node 602 via network 604.

Various adaptations of application monitor component 350 in FIG. 3, such as application monitor components 450 in FIG. 4a, FIG. 4b, and FIG. 4c, and application monitor component 550 in FIG. 5, may in various aspects identify a UI element presented by an application by being included in processing by an IPU for presenting and/or otherwise managing a UI element and/or data processed by the application represented in the UI element. Identifying a UI element may include receiving an indication to present the UI element, receiving information identifying the UI element, detecting an access to a resource for presenting the UI element, and/or detecting an input corresponding to the UI element. Identifying a UI element may include communicating information via a function, subroutine, method invocation, and/or other form of invocation configuring an IPU to access a specified addressable entity included in and/or managing presenting a UI element. Identifying a UI element may include communicating information via an interprocess communication (IPC) mechanism, a message transmitted via a network, and/or a shared region of a storage medium.

In various adaptations, one or more of application monitor components 450 in FIG. 4a, FIG. 4b, and FIG. 4c may interoperate with respective user interface handlers 416 to present some or all of a UI element. In another adaptation, application monitor component 550 in FIG. 5 may interoperate with template engine 518 to present some or all of a UI element. Additionally or alternatively, application monitor component 550 may interoperate with a component, such a request handler operating in network application 504 for accessing data represented and/or to be represented in a UI element in application presentation space 708b1 in FIG. 7b in first application window 704b1 presented by browser 404b in FIG. 4b.

In another example, application monitor component 450a, in FIG. 4a, may subscribe to an event queue of presentation controller 418a. Presentation controller 418a may notify subscribers of various operations and/or changes associated with various output and/or input operations of application 404a. Application monitor component 450a may identify first application window 704a1 in FIG. 7a and/or included UI elements presented by application 404a.

In another example, application monitor component 450b in FIG. 4b may be included in and/or include a UI element handler 416b. Application monitor component 450b may identify first application window 706b1 in FIG. 7b and/or included UI elements presented by a user interface handler 416b. Additionally or alternatively, when including and/or included in a UI element handler 416b, application monitor component 450b may send information, for example via a call to GUI subsystem 420b, to present a UI element or a portion thereof, and may identify the UI element.

In still another example, application monitor component 450c may control access to data to present in a UI element and/or may control access to a resource for presenting the UI element. Detecting an access to a resource for presenting the UI element may include detecting an access to one or more of a font, a text string, image data, audio data, a code library routine, an output device, a driver for an output device, and a presentation space for presenting at least a portion of the UI element. An access to a resource, for example by presentation controller 418c1 and/or UI element handler 416c1 for presenting first application window 704c1 and/or an included UI element may be intercepted and/or otherwise detected by application monitor component 450c. Application monitor component 450c may identify the UI element based on information received and/or otherwise detected by application monitor component 450c in the access attempt.

In yet another example, application monitor component 450b may detect a request to a resource provider, such as network application 504, by browser 404b and/or network client application 406b in FIG. 4b via network 604. The request may identify a web page including a UI element for including a representation of data processed by network application 504 and/or network application client 406b. Additionally or alternatively, application monitor component 450b may be included in processing some or all of a message received from network application 504 via network 604 by browser 404b and/or network application client 406b. A resource may include a web page sent by network application 504. Application monitor component 450b may be included in and/or otherwise may interoperate with a content handler 414b configured to process received data according to its type. For example, application monitor component 450b may identify a UI element based on an element included in a document object model (DOM) created based on an XML and/or HTML type user interface specified in the received web page. The UI element identified may include a form in a web page received from application provider node 606 via network 604. One or more application monitors may operate in, may include, and/or may otherwise interoperate with one or more content handlers 414b to identify a UI element presented by browser 404b, web application client 406b, and/or by network application 504.

FIG. 4b illustrates application monitor component 450b operating in presentation controller 418b. FIG. 4a illustrates application monitor component 450a operating in application 404a external to presentation controller 418a. In various aspects, an application monitor may be included in and/or include one or more components included in processing and/or management of one or more UI elements of an application.

In another aspect, application monitor component 450c may monitor a user interface handler included in and/or accessible via GUI subsystem 420c. For example, second application window 704c2 may be presented by a UI element handler 416c2 sub-classed from a parent class included in a UI element handler provided by a code library included in and/or otherwise accessible to GUI subsystem 420c. Application monitor component 450c may be included in and/or include such a UI element handler. In order to present a visual UI element, application 404c in FIG. 4c invokes and/or otherwise interoperates with GUI subsystem 420c to present the UI element on a display device. Other types of output, such as audio operate analogously with applications invoking and/or otherwise interoperating with an audio subsystem (not shown) to present an audio UI element (e.g. a sound) to a user. In various aspects, application monitor component 450c may be included in processing and/or otherwise managing a request from second application 404c2 to present a UI element. Further, application monitor component 450c may be included in maintaining a presented UI element providing functionality and features on behalf of an application 404c presenting the UI element. In any of these aspects, an application monitor may be configured to identify a UI element presented by an application including a representation of data processed by the application.

Exemplary resources for accessing an output device include a semaphore, a lock, a presentation space, a graphics subsystem, a display adapter, a display device, an audio adapter, an audio output device, a tactile output subsystem, a tactile output device, an access control component, a serialization component, and a synchronization component. As defined above a presentation space includes a storage location in at least one of a processor memory, a secondary data storage medium, a memory of an output adapter device, and a data storage medium included in the output device.

Those skilled in the art will recognize that an application monitor may be included in other components of a visual output subsystem and analogously may be included in other types of output subsystems such as audio and tactile output subsystems.

In still another aspect, identifying a UI element may include a message received via a network and/or a message for sending via a network. For example, application monitor component 550 is illustrated in FIG. 5 operating in network application platform 506 servicing one or more network applications, such as network application 504. Requests for resources including one or more presentable UI elements and messages transmitting resources to clients for presenting one or more UI elements in application presentation space 708b2 in FIG. 7b provided by browser 404b in FIG. 4b are processed by network application platform 506 mediating communications between network application 504 and one or more or network stack 508 and application protocol layer 510. Application monitor component 550 may be included in processing and/or managing one or more requests or types of requests, and/or one or more messages sent to browser 404b or other client of a network application 504. Application monitor component 550 may, detect a request and/or response processed by a network application 504 and/or network application platform 506.

For example, a request and/or response processed by network application 504 and/or network application platform 506 may be processed in response to user input, detected by user node 602, corresponding to a UI element presented on a output device of user node 602.

Application monitor component 550, in an aspect, may be adapted to operate in one or more network applications included in processing and/or managing one or more UI elements. For example, some or all of application monitor component 550 may be included in a script provided to and/or in web application client 406b in FIG. 4b by network application 504 in FIG. 5. The script, when operating in browser 404b, may send a message via network 604 to network application 504 operating in application provider node 606. The message may include information identifying a UI element presented via an output device of user node 602 by web application client 406b and/or browser 404b interoperating with network application 504.

In various aspects, various types of UI elements may be identified. An identified UI element may include and/or may be included in a window, a textbox, an input control, a button control, a check box, a radio button, a slider, a progress bar, a list box, a drop-down list, a spinner, a menu, a menu item, a menu bar, a tool button, a toolbar, a ribbon, a combo box, a tree view, a grid view, a tab, a scrollbar, a label, a pane, a tooltip, a text element, a balloon, and/or a dialog box.

Returning to FIG. 2, block 252 illustrates the method further includes identifying an idle period by determining the user interface element is not updated, by the application in response to a change in the data, during the idle period. Accordingly, a system for identifying an idle user interface element includes means for identifying an idle period by determining the user interface element is not updated, by the application in response to a change in the data, during the idle period. For example, as illustrated in FIG. 3, idle monitor component 352 is configured for identifying an idle period by determining the user interface element is not updated, by the application in response to a change in the data, during the idle period.

FIG. 4a, FIG. 4b, and FIG. 4c illustrate idle monitor components 452 as adaptations and/or analogs of idle monitor component 352 in FIG. 3. One or more idle monitor components 452 operate in an execution environment 402. In FIG. 4a, idle monitor component 452a is illustrated as a component of application 404a. In FIG. 4b, idle monitor component 452b is illustrated as component of network application client 406b. In FIG. 4c, idle monitor component 452b is illustrated operating external to one or more applications 404b. Execution environment 402c includes idle monitor component 452c in its presentation subsystem in GUI subsystem 420c. In FIG. 5, idle monitor components 552 are illustrated network application platform 506.

Exemplary data processed by an application and represented in a UI element of an application include data in an addressable entity in the application, data received in response to a user input, data received from another application, data accessed from a persistent data storage medium, data received via a network, and/or data generated by an application.

In an aspect, identifying an idle period includes detecting no indication of a change to at least one of the data and the representation during a period at least partially included in the idle period. Alternatively or additionally, identifying an idle period includes detecting no access to a resource for changing the at least one of the data and the representation during a period at least partially included in the idle period. Also, alternatively or additionally, identifying an idle period includes detecting no communication for changing the at least one of the data and the representation during a period at least partially included in the idle period. The UI element presented may be moved, resized, minimized, maximized, restored, and/or changed in some other manner responsive to an event other than a change in the data represented in the UI element processed by the application.

User interface information may be filtered by one or both of an idle monitor component 352 and an application monitor component 350 in the various aspects. Identifying an idle period for a UI element may be based on, for example, a type of at least a portion of the data, a task performed by an application, a user, a group, a role, and/or an attribute of a UI element.

For example, idle monitor component 452c in FIG. 4c may receive user interface information including a filter matching all UI elements presenting a representation of data processed by respective applications. In another example, idle monitor component 452a may receive user interface information matching only interface elements presented by application 404a. In still another example, idle monitor component 452b in FIG. 4b and/or idle monitor component 552 in FIG. 5 may receive user interface information matching certain specified types of UI elements, such as UI elements including forms.

In still another aspect, an idle period may be identified based on a type of the data represented. For example, idle monitor component 552 in FIG. 4c may receive user interface information matching UI elements including representations of streamed data and/or real-time data. Idle monitor component 552 may receive user interface information for identifying idle periods for UI elements including status data, such as, presence information.

In yet another aspect, an idle period may be identified based on one or more particular applications that present UI elements. For example, idle monitor component 452c in FIG. 4c may receive idle information for word processing and drawing applications. The applications may be identified and/or matched, based on a task including an operation of an application, a user of the application, and/or a role played by a user of the application and/or by the application. For example, idle monitor component 552 in FIG. 5 may identify an idle period for a UI element identified by a session identifier.

An idle period may be identified based on a user detectable attribute of a UI element. For example, application monitor component 450c and/or idle monitor component 452c may detect a UI element and/or identify an idle period based on a location of part or all of the UI element in a presentation space. In one aspect, application monitor component 450c may detect a location of some or all of first application window 706c1 presented by, for example, application 404c1, in display presentation space 702c. The location may be detected based on information accessible in GUI subsystem 420c. Application monitor component 450c may identify whether some or all of first application window 706a1 is included in a particular location. Alternatively or additionally, idle monitor component 452c may select application 404c1 and/or first application window 704c1, identified by application monitor component 450c, based on a location in display presentation space 702c and/or another attribute accessible via GUI subsystem 420c.

In another aspect, identifying an idle period may include monitoring access to data represented in a UI element. For example, idle monitor component 452a in FIG. 4a may subscribe to an event queue of a UI element handler 416a for application presentation space 708a and/or a component included in application 404a configured to process the data represented in application presentation space 708a. Idle monitor component 452a may receive notifications including change information, as a subscriber, indicating changes to application presentation space 708a, the data represented by one or more data representations 714a, and/or a resource associated with presenting one or more of the representations 714a of the data and/or otherwise associated with processing the data by application 404a.

Other adaptations and/or analogs of activity monitor 352 may receive change information in an analogous manner. In FIG. 4b, data represented in a UI element may be status information received in status notifications from a publishing service operating in execution environment 402b and/or operating in a remote node operatively coupled via a network. In an aspect, idle monitor component 452b may be an agent for interoperating with the publishing service to receive status notifications identifying changes to the data.

In another aspect, idle monitor component 452a in FIG. 4a may be included in and/or include a UI element handler, thus idle monitor component 452a may receive and/or intercept an indication to present a change to the UI element corresponding a change in the data represented. When including and/or included in a UI element handler 416a, idle monitor component 452a may send information, for example as a publisher associated with the data, to notify other components of changes to the data.

In another aspect, idle monitor component 552 in FIG. 5 may control access to some or all of the data represented in a UI element. For example, the data may be stored in model database 516. An access to change the data by via browser 404b and/or web client application 406b may be detected by idle monitor component 552.

For example, idle monitor component 452b in FIG. 4b may detect a request to a resource provider, such as network application 504, sent via network 604. Additionally or alternatively, idle monitor component 452b may be included in processing some or all of a message received from a resource provider via network 604. Idle monitor component 452b may detect updates to a UI element based on information in a request and/or in a response. Idle monitor component 452b may determine based on the request and/or the response whether the update is in response to a change in data represented in the UI element. For example, idle monitor component 452b may identify an idle period based on monitoring changes to a DOM for an XML and/or HTML portion included in a web page. The web page may be received and identified in one or more requests and/or in one or more responses during a period of time according to a particular measure of time.

FIG. 4b illustrates idle monitor component 452b operating in presentation controller 418b, and FIG. 4a illustrates idle monitor component 452a operating in application 404a external to presentation controller 418a. Various adaptations of idle monitor component 352 in various aspects may be included in and/or include one or more components in an application included in processing and/or management of one or more UI elements and/or the data represented in the one or more UI elements of the application.

In various aspects, idle monitor component 452c, in FIG. 4c, may identify an idle period for a UI element via subscribing to an event queue of a UI element handler or other component included in updating some or all of a UI element and/or in updating the data represented in the UI element. The UI element handler (not shown) may be provided by a code library included in and/or otherwise accessible to GUI subsystem 420c. Idle monitor component 452c may be included in and/or include such a UI element handler.

In order to update a UI element in response to a change in data represented in the UI element, application 404c in FIG. 4c may invoke and/or otherwise interoperate with GUI subsystem 420c to update the UI element presented by a display device. Other types of output may be updated as described above for other types of output devices via an analogous type of output subsystem, such as audio subsystem for an audio device. In various aspects, idle monitor component 452c may be included in processing and/or otherwise managing a request from application 404c to GUI subsystem 402c to update a UI element and/or data represented in the UI element. Further, idle monitor component 452c may be included in maintaining a presented UI element providing functionality and features on behalf of application 404c.

In FIG. 5, idle monitor component 552 is illustrated operating in network application platform servicing one or more network applications. As with an application monitor component 550, an idle monitor component 552 may be included in processing and/or managing of one or more requests or types of requests and/or one or more messages sent to a client of network application 504. In an aspect, idle monitor component 552 may identify an idle period for a UI element of network application 504 by detecting updates to the UI element sent in a message to a client and/or requested in a message from the client.

An idle monitor component, in an aspect, may also be adapted to operate in network application 504 included in processing and/or managing one or more UI elements for network application 504. For example, some or all of an idle monitor may be included in a request handler (not shown) included in model subsystem 514 in network application 504. The request handler may process form data. The processing may result in a response sent to a requesting client to update a corresponding UI element in response to a change in the form data and/or in other data based on the form data. Identifying an idle period may include determining a time period during which no such requests for updating a UI element and/or data represented in the UI element are received. Idle monitor component 552 may determine a time period during which no requests for updating a UI element in application presentation space 708b1 in first application window 704b1 presented by browser 404b are detected for processing by a request handler in network application 504. Idle monitor component 552 may identify an idle period based on the determined time period.

Identifying an idle period may be determined based on an absolute measure of time and/or a relative measure of time. For example, idle monitor component 452b may identify an idle period by detecting a timer expiration of a timer set with a specified duration, and/or may identify an idle period determined based on a relative measure of time, for example by counting and comparing events that occur in time

More specifically, idle monitor component 452a may detect inputs for a UI element and/or the included data representation presented by application 404a. When an input is detected, a timer may be set with a specified duration. If the timer expires prior to detecting another input event, idle monitor component 452a may identify an idle period for the UI element. An idle period may include a determined period during which no user input is received corresponding to the representation.

A time period may be measured in user inputs, CPU cycles, or any suitable event type. In an aspect, user inputs may be counted to measure time among applications 404 in an execution environment 402. For example, a period may be determined where one hundred user inputs events are detected directly or indirectly via idle monitor component 452c in FIG. 4c. During the period, idle monitor component 452c may determine a first UI element presented by user interface handler 416c1 has been changed three times in response to changes in the data processed by first application 404c1 and represented in the first UI element. During the period of one hundred detected user inputs, idle monitor component 452c may determine that a second UI element presented by second application 404c2 has not been updated in response to any changes in data processed by second application 404c2 and represented in the second UI element. Idle monitor component 452c may identify that an idle period with a duration of one hundred user input events has occurred based on an idle condition comparing updates to the first UI elements and the second UI element. Thus relative measures of time as just described are within the scope of the subject matter described herein.

An idle period may be identified based on a type of input other than user input and/or in addition to a user input. Identifying an idle period may include determining a period during which no input is received by an application for changing the data. Exemplary sources of input include a network interface, a user, and/or a sensor

Identifying an idle period may include receiving a message identifying a period of time from an application presenting a UI element. For example, idle monitor component 452c may receive an indication from application 404c2 indicating an idle period has been identified for a UI element presented by application 404c2. Application 404c2 may include an idle monitor component analogous to idle monitor component 452a operating in application 404a in FIG. 4a. Receiving an indication from an application of an idle period may include receiving a communication from the application indicating no change in the data. The idle period may be identified in response to the communication.

Identifying an idle period may include receiving and/or not receiving a message from a remote node via a network. For example, idle monitor component 452b in FIG. 4b may receive a message indicating that idle monitor component 552 has identified an idle period. Idle monitor component 552 may identify a period of time where data represented by one or more of representations 714b presented by network application client 406b in FIG. 4b remains unchanged. Alternatively or additionally, idle monitor component 452b in FIG. 4b may detect a message from network application 504 in FIG. 5 including data for updating a representation 714b.

Other exemplary mechanisms for identifying an idle period by various adaptations of idle monitor component 352 in FIG. 3 in various aspects include detecting an expiration of a timer and/or any other event that identifies a boundary of an idle period. Whether an event identifies a boundary of an idle period may be determined based on one or more of attributes of an UI element. Exemplary attributes include an input focus setting, a location in a presentation space of at least a portion of the UI element, a z-order, a transparency level, and/or a size of at least a portion of the UI element.

Whether an event identifies a boundary of an idle period may be determined based on one or more attributes of the data represented. Exemplary attributes of the data include a type of at least a portion of the data, a source of the data, a time associated with the data, a type of the output device, a task performed based on the data, a transaction including an operation performed based on the data, a protocol for communicating at least a portion of the data via a network, an operational state of the application processing the data, a state of a thread processing the data, a power state of a device included in processing the data, and/or a security attribute associated with the data.

Whether an event identifies a boundary of an idle period may be determined based on a task performed by the application, a transaction including an operation performed by the application, a user of the application, a security attribute of the application, and/or a protocol for communicating the data represented in the UI element between the application and another node in a network.

Whether an event identifies a boundary of an idle period may be determined based on one or more of a change in an operational state of some or all of the application, in a status of a user of the application, and in a status of the device hosting at least a portion of the application. The application may be a media player, and the operational state of the application may be a play state, a pause state, a stop state, a rewind state, and/or a fast forward state. The operational state of at least a portion of the application may be a state of a thread included in a process including the operating application and the thread state during at least part of the identified idle period is not an executable state. Identifying an idle period may include identifying a time period during which a thread in the application is not in an executable state

In any of the exemplary aspects, an idle monitor may be configured to detect changes and thus identify idle periods when no updates are detected to a UI element presented by an application including a representation of data processed by the application. Those skilled in the art will recognize that an idle monitor may be included in other components of a visual output subsystem and analogously may be included in other types of output subsystems providing audio, tactile, and other types of user detectable user interface presentations.

In various adaptations of idle monitor component 352 in FIG. 3, such as idle monitor components 452 in FIG. 4a, FIG. 4b, and FIG. 4c, and idle monitor component 552 in FIG. 5, identifying an idle period may be based on various types of measures of time and an idle monitor may interoperate with various components for measuring time. Identifying an idle period may include measuring time in regular increments as is typical, and/or measuring time based on events that may be occur irregularly over a given period. For example, time may be measured in seconds by a processor clock, in instructions executed by a processor, in input events detected by one or more user input devices, and/or in bytes and/or messages received via a network.

By processing and/or otherwise monitoring changes to a UI element over a period of time, an idle period may be identified. A timer component may be set to at a particular time with a given duration. Detecting an expiration of the timer may indicate an idle period when the timer has not been reset in response to an update to the UI element resulting from a change in the data represented. A time period may be determined and/or identified indirectly through detecting the occurrence of other events that bound and/or occur in a period of time. A time period may have a fixed or varying duration in various aspects.

Returning to FIG. 2, block 254 illustrates the method further includes determining that a specified idle condition for the idle period is met. Accordingly, a system for identifying an idle user interface element includes means for determining that a specified idle condition for the idle period is met. For example, as illustrated in FIG. 3, idle policy component 354 is configured for determining that a specified idle condition for the idle period is met.

FIG. 4a, FIG. 4b, and FIG. 4c illustrate idle policy components 454 as adaptations and/or analogs of idle policy component 354 in FIG. 3. One or more idle policy components 454 operate in an execution environment 402. In FIG. 4a, idle policy component 454a is illustrated as a component of application 404a. In FIG. 4b, idle policy component 454b is illustrated as component of network application client 406b. In FIG. 4c, idle policy component 454c is illustrated operating external to one or more applications 404c. Execution environment 402c includes idle policy component 454c in its presentation subsystem. In FIG. 5, idle policy component 554 is illustrated operating in network application platform 506.

Various adaptations of idle policy component 354 in FIG. 3, such as idle policy components 454 in FIG. 4a, FIG. 4b, and FIG. 4c, and idle policy component 554 in FIG. 5, in various aspects may receive and/or determine idle condition information identifying an idle condition. The idle condition is specified for determining whether a UI element associated with an idle period is idle. The idle condition may be identified by a corresponding adaptation of idle monitor component 352 in FIG. 3.

In an aspect, an idle condition may be based on a duration of an idle period. An idle condition may be evaluated based on a duration of an idle period, and/or an idle condition may be selected based on a duration of an idle period.

For example, a measure of a duration of an idle period may be provided as input to idle policy component 454a in FIG. 4a for testing and/or otherwise evaluating a specified idle condition. A variety of idle conditions may be tested in various aspects. An idle condition may be evaluated to determine whether a duration of an idle period meets a specified idle threshold duration. A threshold duration in an idle condition may be conditional. For example, an idle condition and/or a threshold duration may be specified based on a type of a UI element, a type of at least a portion of represented data, a task performed by the application, a user, a group, a role, an attribute of a UI element, user detectable attribute of the application, an input to another application, an output of another application, a message transmitted via a network, a measure of energy, a count of UI elements in a presentation space, a count of active applications, a relationship of an application to another application, a geospatial location, and/or an application operating in an application.

An idle condition may be relative. For example, an adaptation and/or analog of idle policy component 354 in various aspects may test an idle condition that includes a comparison based on another UI element or other entity. For example, idle policy component 454a in FIG. 4a, in an aspect, may evaluate an idle condition that specifies that a first UI element is idle when both a second user interface is idle and the duration of the idle period of the first UI element exceeds the duration of the idle period of the second UI element. In another example, idle monitor component 452b in some aspect, may measure a duration of an idle period based on counting and/or otherwise detecting one or more events that bound a period of time. Second application presentation space 708b2 may be determined to be idle by idle policy component 454b based on an idle condition that specifies that presentation space 708b2 has received no input events while a specified total count of input events has been detected by idle monitor component 452b.

In FIG. 4a, idle policy component 454a operates in application 404a. One or more conditions for testing based on a duration of a idle period may be specified to application 404a and/or specified for testing by idle policy component 454a. A condition may be included in an application, for example, by specifying the condition in the code of the application. A condition may be configurable by a user and/or by another component.

In FIG. 4a and analogously in other adaptations of the arrangement in FIG. 3, idle monitor component 452b may provide idle period information identifying a duration of an identified idle period to idle policy component 454b. Idle policy component 454b may test an idle condition, identified as described above, to determine whether the idle condition is met.

An idle period may have one or more durations. A particular duration may be measured based on one or more different types of measurements. For example, idle monitor component 452c in FIG. 4c may measure a duration via interoperating with a processor clock and/or other clock device in execution environment 402c. The same and/or different idle period may be measured in user input events detected as described above.

An idle period may include one or more other types of detectable time periods. Exemplary time periods at least partially included in an idle period include a period during which no user input is detected corresponding to one or more UI elements, a period of time during which an application visual interface is minimized, a period of time during which no persistent storage medium is accessed by an application, a period of time during which no data is exchanged with an application or portion of the application via a network, a period of time a UI element is hidden, and a period during which a UI element has not had input focus. An idle condition may be based on one or more durations of an identified idle period.

In an aspect, idle policy component 454a in FIG. 4a may be configured with a network identifier of a power management service (not shown) operating in a remote node. The power management service may maintain configured idle conditions for detecting idle UI elements to raise the awareness of users of energy and other resources that are possibly being used unnecessarily. When idle policy component 454a receives idle period information from idle monitor component 452a, idle policy component 454a may send a message via network stack 408a and optionally application protocol layer 410a to retrieve an idle condition for testing, a parameter for an idle condition, and/or to request power management service to at least partially evaluate an idle condition.

In another aspect, idle monitor component 452b in FIG. 4b may retrieve and/or otherwise receive an idle condition for evaluation from network application 504 and/or network application platform 506 in FIG. 5. The idle condition may be included in web client application 406b, and/or may be generated by web client application 406b when operating in browser 404b. For example, a received idle condition may test whether a UI element with an identified idle period in a tab of browser has been visible within a duration at least partially included in the idle period. In another example, an idle condition may be associated with a UI element included in a presentation space in a tab or window of browser 404b. An evaluation of the idle condition by idle policy component 454b may determine whether the condition is met for a portion of the presentation in the window or tab including the UI element.

In still another aspect, idle policy component 454c in FIG. 4c operates external to an application having a UI element with an identified idle period. Idle policy component 454c may test an idle condition for detecting whether any number of UI element are idle in any number of applications.

In yet another aspect idle policy component 554 in FIG. 5 operating in network application platform 506 may identify and test an idle condition based on a duration of an idle period of a UI element of network application 504 serviced by network application platform 506. Idle conditions tested in various aspects by idle policy component 554 include and/or are analogous to conditions described above with respect to FIG. 4a, FIG. 4b, and FIG. 4c. For example, idle policy component 554 may test a condition based on duration in which no notifications have been received from a publish-subscribe service providing updates to data represented in a UI element of web client application 406b in FIG. 4b. If the no-notification period is included in the idle period and a duration of the no-notification period matches a duration threshold and/or a count, for example, idle policy component 554 may determine the condition is met.

Various adaptations and/or analogs of idle monitor component 352 in FIG. 3 may receive and/or evaluate an idle condition based on a user detectable attribute of an application, a task performed by an application, an input to an application, an output of an application, a user, a group, a role, an access privilege, a message received via a network, a measure of energy, a count of UI elements, a count of active applications, a relationship of an application to another active application, a geospatial location, and/or a current state of a transaction. For example, an idle condition may include evaluating a measure of power available in a battery in determining whether the condition is met. An application performing an operation in a particular task may have a longer threshold that an idle period duration must match than an application performing an operation in another task.

Returning to FIG. 2, block 256 illustrates the method additionally includes sending, in response to determining the idle condition is met, idle information to present a user detectable idle indication for the user interface element. Accordingly, a system for identifying an idle user interface element includes means for sending, in response to determining the idle condition is met, idle information to present a user detectable idle indication for the user interface element. For example, as illustrated in FIG. 3, policy agent component 356 is configured for sending, in response to determining the idle condition is met, idle information to present a user detectable idle indication for the user interface element.

FIG. 4a, FIG. 4b, and FIG. 4c illustrate policy agent components 456 as adaptations and/or analogs of policy agent component 356 in FIG. 3. One or more policy agent components 456 operate in an execution environment 402. In FIG. 4a, policy agent component 456a is illustrated as a component of application 404a. In FIG. 4b, policy agent component 456b is illustrated as component of network application client 406b. In FIG. 4c, policy agent component 456c is illustrated operating external to one or more applications 404c. Execution environment 402c includes policy agent component 456c in its presentation subsystem. In FIG. 5, policy agent component 556 is illustrated operating in network application platform 506.

Various adaptations of policy agent component 356 in FIG. 3, such as policy agent components 456 in FIG. 4a, FIG. 4b, and FIG. 4c, and policy agent component 556 in FIG. 5, in various aspects may receive instruction to present an idle indication to a user that a UI element is idle when a corresponding adaption of idle policy component 354 determines that a specified idle condition is met for an idle period. The idle indication is presented by sending idle information to a component of a presentation subsystem and/or device to present to a user. Sending may be performed by any suitable mechanism including an invocation mechanism, such as function and/or method call utilizing a stack frame; an interprocess communication mechanism, such as a pipe, a semaphore, a shared data area, and/or a message queue; a register of a hardware component, such as an IPU register; and/or a network communication, such as an HTTP request and/or an asynchronous message.

In one aspect, policy agent component 456a in FIG. 4a may include a UI element handler for presenting an idle indication. The UI element handler in policy agent component 456a may send idle information by invoking GUI subsystem 420a to present an indication by the same output device presenting the idle UI element and/or by another output device. Alternatively or additionally, policy agent component 456a may interoperate with the user interface handler presenting some or all of the idle UI element to change an attribute of the UI element as an indication that the UI element is idle. For example, policy agent component 456a may send color information to present the UI element in black and white rather than color as active UI elements are presented. Idle information may include information for changing a border thickness of at least portion of the idle UI element may be sent to GUI subsystem 420a to present an indication that the UI element is idle. FIG. 7a illustrates first application window 704a1 presented in a darkened background 716a1 in a region of display presentation space 702a. FIG. 7b illustrates an idle resource use interface element 714b22 presented with a thicker border 716b1 than active resource UI elements 714b.

In FIG. 4b, policy agent component 456b may be instructed to present an idle indication for a UI element by idle policy component 454b and/or by idle policy component 554 in FIG. 5, in response to determining that an idle condition is met. Idle information may include information for changing a user detectable attribute of a browser tab or window including the idle UI element.

In another aspect, idle information may be sent to close an idle UI element, present a selectable user interface control for subsequently presenting the UI element in response to a user selection of the selectable control. A selectable UI element may be at least one of included in the application and included in another application. For example, policy agent component 456b may send idle information to close a browser window or tab including an idle UI element and store a link or other representation of the idle UI element in a history list and/or an idle windows list of browser 404b as an idle indication. A user may select the link or representation indicating the UI element is idle to retrieve some or all of an idle UI element from a browser cache and/or to send a request to a network application 504 to restore and/or present a new or restored UI element replacing the idle UI element.

In an aspect, a containing window or pane of an application UI element is provided by a library routine of GUI subsystem 420c. Policy agent component 356c may change a user detectable attribute of the containing UI element. For example, policy agent component 456c may send idle information for moving the UI element to a region of a presentation space designated for presenting an idle UI element, presenting a representation of the UI element on another output device, altering an orientation of the UI element, and/or changing a user detectable attribute of the UI element designated to indicate an idle UI element. In an aspect, policy agent component 456 may change a pointing device representation, such as mouse pointer when it approaches and/or is in a location of a presented idle UI element to indicate the UI element is idle. FIG. 7c illustrates application bar 718c including first app icon 716c1, second app icon 716c2, and third app icon 716c3 corresponding, respectively, to first application window 704c1, second application window 704b2, and third application window (not shown). First icon 716c1 may be presented with a different color and/or coloration pattern to indicate that first application window 704c1 is an idle UI element.

Policy agent component 456c may interoperate with another output device to present an idle indication. For example, a pointing device may also be a tactile output device. Policy agent component 456c may instruct the pointing device to vibrate when a corresponding pointer UI element is presented over an idle UI element.

In FIG. 5, policy agent component 556 in network application platform 506 may send information via a response to a request and/or via an asynchronous message to a client, such as browser 404b and/or web application client 406b, to present a user detectable idle indication that a UI element, of network application 504 serviced by network application platform 506, is idle.

In an aspect, a UI element of web client 406b may present updates to information received by network application 504 from a publish-subscribe server. Policy agent component 556, in the aspect, may send idle information rather than change information for the represented data. The idle information may alter an attribute of an idle UI element to indicate the represented data is stale and/or idle.

In various aspects a user detectable indication may include a representation of time such a frozen clock face or an operating clock face showing a current idle duration; a change in an attribute of an idle UI element, such as z-order, a level of transparency, a location in a presentation space, a size, a shape, and/or input focus state; and/or a new UI element, such as a pop-up message and/or a fly-over UI element. A location for presenting the indication may be based on a location of the idle UI element and/or may be a location determined prior to detecting the UI element.

A user detectable indication that a UI element is idle may be presented on a same output device as the idle UI element and/or a different output device. The idle indication may be presented via a visual output device, an audio output device, a tactile output device, and another type of output device.

A user detectable indication that a UI element is idle may be presented for a specified duration of time, until a specified event is detected, and/or may include a pattern of changes presented to a user. For example, an idle indication may be presented until a user input is detected that corresponds to the indication forcing a user to acknowledge the indication to make it disappear. The UI element may be made active in response to a user input detected corresponding to an idle indication and/or a corresponding UI element.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more instruction processing units, or by a combination of both. The description herein of any sequence of actions is not intended to imply that the specific order described for performing that sequence must be followed.

Moreover, the methods described herein may be embodied in executable instructions stored in a computer readable medium for use by or in connection with an instruction execution machine, system, apparatus, or device, such as a computer-based or processor-containing machine, system, apparatus, or device. As used herein, a “computer readable medium” may include one or more of any suitable media for storing the executable instructions of a computer program in one or more of an electronic, magnetic, optical, electromagnetic, and infrared form, such that the instruction execution machine, system, apparatus, or device may read (or fetch) the instructions from the computer readable medium and execute the instructions for carrying out the described methods. A non-exhaustive list of conventional exemplary computer readable medium includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating any non-claimed element is essential to the practice of the subject matter as claimed.

I claim:

1. A method for identifying an idle user interface element, the method comprising:
identifying a user interface element, including a user detectable representation of data processed by an application, presented by the application via an output device;
identifying an idle period by determining the user interface element is not updated, by the application in response to a change in the data, during the idle period;
determining that a specified idle condition for the idle period is met; and
sending, in response to determining the idle condition is met, idle information to present a user detectable idle indication for the user interface element.

2. The method claim 1 wherein identifying the idle period includes at least one of detecting a period during which no indication of a change to at least one of the data and the representation is detected, no access to a resource for changing the at least one of the data and the representation is detected, and no communication for changing the at least one of the data and the representation is detected.

3. The method claim 1 wherein identifying the idle period included identifying the idle period based on at least one of a type of the user interface element, a type of at least a portion of the data, a task performed by the application, a user, a group, a role, and an attribute of the user interface element.

4. The method claim 1 wherein identifying the idle period includes identifying the idle period based a relative measure of time.

5. The method claim 1 wherein identifying the idle period includes detecting a boundary event identifying at least one of a start, an end, and a time in the idle period.

6. The method claim 1 wherein identifying the idle period includes detecting a time period during which a thread in the application is never in an executable state.

7. The method claim 1 wherein identifying the idle period includes measuring at least a portion of a duration of the idle period based on detecting events that occur irregularly compared to the duration as measured by a processor clock.

8. The method of claim 1 wherein at least one of the idle condition is identified based on a duration of the idle period and determining whether the idle condition is met includes evaluating the idle condition for determining whether a duration of the idle period meets a threshold condition.

9. The method of claim 1 wherein determining the idle condition is met includes evaluating the idle condition including on a comparison based on another user interface element.

10. The method of claim 1 wherein the idle period at least partially includes a period during which at least one of the user interface element includes and is included in a user interface element that is minimized, no persistent storage media are accessed by the application, no data is exchanged between the application and a remote node via a network, at least a portion of the user interface element is hidden, and the user interface element has not had input focus.

11. The method of claim 1 wherein the idle indication is at least one of included in the user interface element and included in a separate user interface element.

12. The method of claim 1 the idle indication includes a user selectable control and the method further comprises:
closing the user interface element; and
presenting the user selectable control, for subsequently presenting the user interface element as an active user interface element, in response to a user input selecting the user selectable control.

13. The method of claim 12 wherein the user selectable control includes a link and the method further comprises:
detecting a user input selecting the link;
retrieving user interface element from at least one of a cache and a remote node; and
subsequently, presenting the user interface element as an active user interface element.

14. The method of claim 1 wherein the user interface element is at least one of moved, resized, minimized, and/or maximized during the identified idle period.

15. The method of claim 1 wherein the idle information includes information for at least one of moving the user interface element to a region of a presentation space designated for presenting an idle user interface element, presenting a representation of the user interface element on another output device, altering an orientation of the user interface element, and changing a user detectable attribute of the user interface element designated to indicate an idle user interface element.

16. The method of claim 1 wherein the idle information includes information for changing a pointer user interface element in response to determining the pointer user interface element is at least partially presented in a specified region including the idle user interface element.

17. The method of claim 1 wherein the method further comprises:
detecting a user input corresponding to at least one of the user interface element and the idle indicator after the presenting of the idle indicator; and
identifying the user interface element as active, in response to detecting the user input.

18. A system for identifying an idle user interface element, the system comprising:
an execution environment including an instruction processing unit configured to process an instruction included in at least one of an application monitor component, an idle monitor component, an idle policy component, and a policy agent component;
the application monitor component configured for identifying a user interface element, including a user detectable representation of data processed by an application, presented by the application via an output device;
the idle monitor component configured for identifying an idle period by determining the user interface element is not updated, by the application in response to a change in the data, during the idle period;
the idle policy component configured for determining that a specified idle condition for the idle period is met; and
the policy agent component configured for sending, in response to determining the idle condition is met, idle information to present a user detectable idle indication for the user interface element.

19. A computer readable medium embodying a computer program, executable by a machine, for identifying an idle user interface element, the computer program comprising executable instructions for:
identifying a user interface element, including a user detectable representation of data processed by an application, presented by the application via an output device;
identifying an idle period by determining the user interface element is not updated, by the application in response to a change in the data, during the idle period;
determining that a specified idle condition for the idle period is met; and
sending, in response to determining the idle condition is met, idle information to present a user detectable idle indication for the user interface element.
